(19) United States
(12) Patent Application Publication
(10) Pub. No.: US 2001/0040490 A1
(43) Pub. Date: Nov. 15, 2001

(54) TRANSMISSION LINE AND TRANSMISSION LINE RESONATOR

(76) Inventor: HIROAKI TANAKA, MISHIMA-GUN (JP)

Correspondence Address: OSTROLENK FABER GERB & SOFFEN, 1180 AVENUE OF THE AMERICAS, NEW YORK, NY, 100368403

(21) Appl. No.: 09/366,387

(22) Filed: Aug. 3, 1999

(30) Foreign Application Priority Data
Aug. 4, 1998 (JP) 10-220449

(51) Int. Cl. H01P 1/203

(52) U.S. Cl. 333/204

(57) ABSTRACT

A transmission line of the present invention produces a small loss and offers good production efficiency at low cost. In the structure of the transmission line, two strip line electrodes are stacked via a dielectric layer, while being mutually connected by via holes disposed at distances not exceeding ¼ of the wavelength of the highest frequency used in the longitudinal direction of the line electrodes. In addition, first ground electrodes are disposed separated by other dielectric layers with respect to the line electrodes. With this arrangement, current concentration at the side edges of the line electrodes is reduced and losses in the transmission line can thereby be reduced. Moreover, since the transmission line can be produced in the same process, production efficiency can be enhanced to achieve cost reduction.

### BACKGROUND OF THE INVENTION

1. Field of the Invention

The present invention relates to transmission lines and transmission line resonators. More particularly, it relates to transmission lines and transmission line resonators formed on dielectric substrates used in high frequency range.

2. Description of the Related Art

FIG. 9 shows a strip line conventionally used as a transmission line. In FIG. 9, the strip line 1 is formed of a strip line electrode 3 formed inside a dielectric substrate 2, and ground electrodes 4 and 5 formed on the upper and lower surfaces of the dielectric substrate 2, the line electrode 3 being hold between the ground electrodes 4 and 5.

FIG. 10 shows another strip line, whose basic structure is shown in Japanese Unexamined Patent Publication No. 62-71303. In FIG. 10, the strip line 10 is formed in such a manner that a micro-strip line, in which a ground electrode 12 is formed on a surface of a dielectric substrate 11 and a strip line electrode 13 is formed on the other surface of the dielectric substrate 11, and another micro-strip line, in which a ground electrode 15 is formed on a surface of a dielectric substrate 14 and a strip line electrode 16 is formed on the other surface of the dielectric substrate 14, are stacked so that the line electrodes 13 and 16 are opposed to each other with a resin sheet 17 therebetween, and further, the mutually opposing line electrodes 13 and 16 are electrically connected by a plurality of conductive materials 18 passing through the resin sheet 17.

In the strip line 1, however, since current concentration occurs at the side edge of the line electrode 3, losses are relatively large. As a result, Q is lowered when these line electrodes, having predetermined lengths, are used as transmission line resonators.

In the strip line 10, since signals flow to the two line electrodes 13 and 16 in the same phase, current concentration at the side edges of the line electrodes 13 and 16 is reduced, and losses are therefore smaller. However, the strip line 10 has a structure in which the resin sheet 17 is disposed between the dielectric substrates 11 and 14 and the conductive material 18 passing through the resin sheet 17 is provided. Consequently, this type of strip line must be produced by multiple processes, leading to lower production efficiency and higher cost.

### SUMMARY OF THE INVENTION

Accordingly, the present invention has been made to solve the above problems. It is an object of the present invention to provide a transmission line and a transmission line resonator with reduced losses and high production efficiency.

To this end, the transmission line of the present invention includes a plurality of strip line electrodes and a plurality of dielectric layers, in which the plural line electrodes are mutually stacked through the dielectric layers so as to be mutually connected through via holes disposed at predetermined distances in the longitudinal direction of the strip line electrodes.

Additionally, in this transmission line, first ground electrodes may be disposed separated by the dielectric layers with respect to the plurality of line electrodes in a direction in which the strip line electrodes are stacked.

In the above-described transmission line, second ground electrodes may be disposed at positions close to the edges of the strip line electrodes, on the same plane as the strip line electrodes are disposed.

Furthermore, in this transmission line, the second ground electrodes may be mutually connected by the via holes disposed at predetermined distances in the longitudinal direction of the strip line electrodes, at positions close to the plurality of strip line electrodes.

Furthermore, in the transmission line described above, the first ground electrodes and the second ground electrodes may be mutually connected by the via holes disposed at predetermined distances in the longitudinal direction of the strip line electrodes, at positions close to the strip line electrodes.

Furthermore, in one of the transmission lines described above, the distance between the via holes may not be more than ¼ of the wavelength of signals of the highest frequency used.

In a transmission line resonator of the present invention, the length of the transmission line has a predetermined length.

Such an arrangement permits the transmission line of the present invention to have reduced losses and to be produced at low cost.

Additionally, in the transmission line resonator of the present invention, losses in the transmission line are reduced, so that Q can be higher.

### BRIEF DESCRIPTION OF THE DRAWINGS

FIG. 1 is a partial perspective view of an embodiment of a transmission line according to the present invention;

FIGS. 2A and 2B show sectional views of the transmission line shown in FIG. 1; FIG. 2A shows a sectional view taken along the plane x-y passing through the center of a via hole, and FIG. 2B shows a sectional view taken along the plane y-z passing through the center of a via hole;

FIGS. 3A and 3B show sectional views of another embodiment of the transmission line according to the present invention; FIG. 3A shows a sectional view taken along the plane x-y passing through the center of a via hole, and FIG. 3B shows a sectional view taken along the plane y-z passing through the center of a via hole;

FIG. 4 is a partial perspective view of another embodiment of the transmission line according to the present invention;

FIG. 5 is a sectional view of the transmission line shown in FIG. 4, taken along the plane x-y passing through the center of a via hole;

FIG. 6 is a sectional view of another embodiment of the transmission line according to the present invention, in which the sectional view is taken along the plane x-y passing through the center of a via hole;

FIG. 7 is a partial perspective view of an embodiment of the transmission line resonator according to the present invention;

FIG. 8 is a sectional view of the transmission line resonator shown in FIG. 7, in which the sectional view is taken along the plane y-z passing through the center of a via hole;

FIG. 9 is a partial perspective view of a conventional transmission line; and

FIG. 10 is a partial perspective view of another conventional transmission line.

### DESCRIPTION OF THE PREFERRED EMBODIMENTS

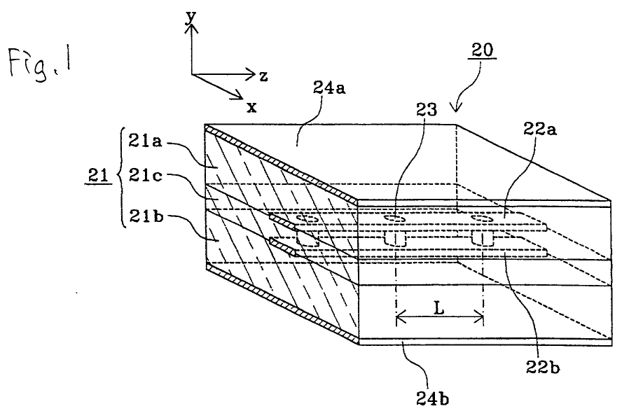

FIG. 1 shows a partial perspective view of an embodiment of the transmission line according to the present invention. In FIG. 1, a transmission line 20 includes a dielectric substrate 21 formed of dielectric layers 21a, 21b, and 21c made of ceramic, resin, or other material, strip line electrodes 22a and 22b, a plurality of via holes 23, and first ground electrodes 24a and 24b.

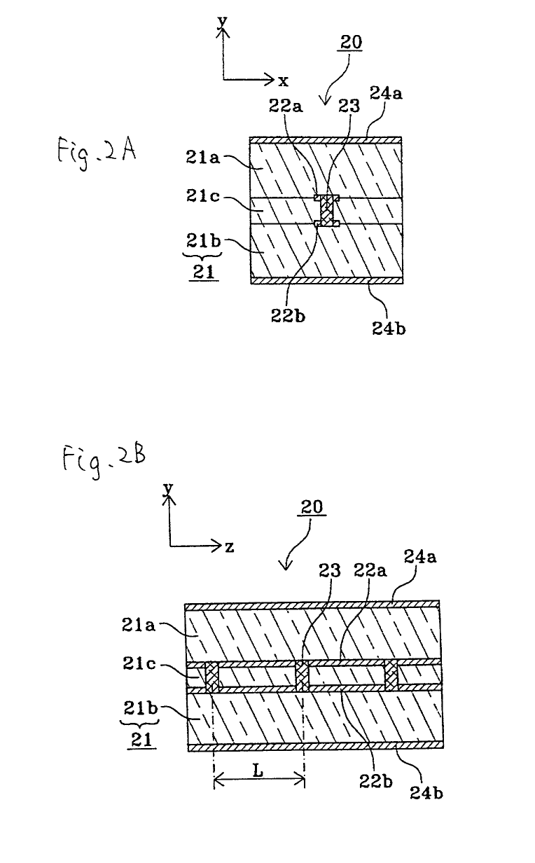

FIGS. 2A and 2B show sectional views of the transmission line 20 shown in FIG. 1. FIG. 2A is a sectional view of the transmission line, taken along the plane x-y passing through the center of a via hole, and FIG. 2B is a sectional view of the transmission line, similarly taken along the plane y-z passing through the center of a via hole.

As shown in FIG. 1, and FIGS. 2A and 2B, in the transmission line 20, the dielectric layers 21a and 21b, holding the dielectric layer 21c therebetween, are stacked in the y-axis direction. The line electrodes 22a and 22b are extended by coinciding their longitudinal direction with the z-axis direction between the dielectric layers 21a and 21c, as well as between the dielectric layers 21b and 21c, in which the line electrodes 22a and 22b are connected by a via hole 23 at every specified distance L. The distance L of the via hole 23 is set to be ¼ or less of the wavelength of signals of the highest frequency used in the transmission line 20. The first ground electrodes 24a and 24b are disposed separated by the dielectric layers 21a and 21b with respect to the line electrodes 22a and 22b.

In the transmission line 20 having such a structure, since the line electrodes 22a and 22b connected by the via hole 23 can be regarded as a single line, the overall transmission line 20 performs the same operation as that of a strip line of a triplate structure. Since the line electrodes 22a and 22b are connected by the via hole 23 at every distance ¼ or less of the wavelength of signals, signals of the same phase are transmitted in the line electrodes 22a and 22b. Consequently, current concentration at the side edges of the line electrodes 22a and 22b is reduced and losses in the transmission line can thereby be reduced.

Moreover, since the line electrodes 22a and 22b, the via hole 23, and the first ground electrodes 24a and 24b can be produced in the same process, that is, by using the process for producing a multi-layer-stacking substrate, production efficiency can be improved and the transmission line with reduced losses can thereby be obtained at low cost.

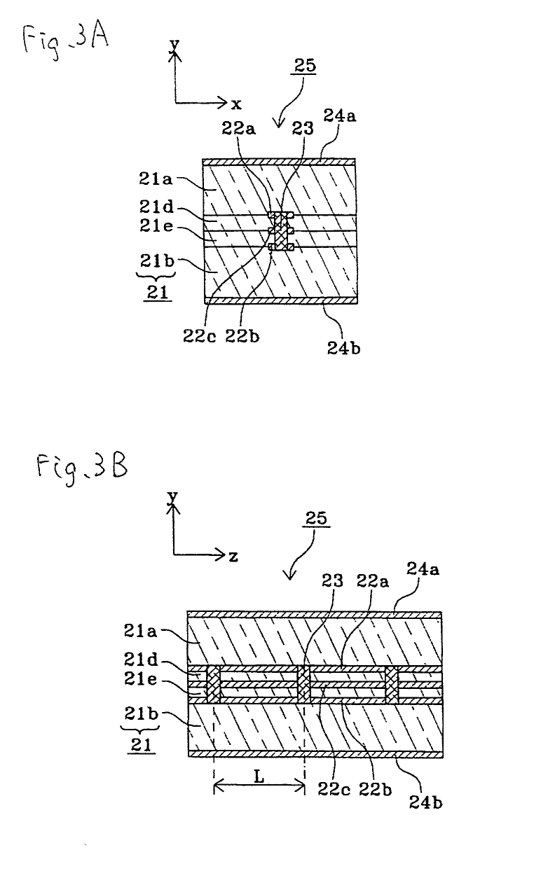

FIGS. 3A and 3B show sectional views of another embodiment of the transmission line according to the present invention. FIG. 3A shows a sectional view of the transmission line, taken along the plane x-y passing through the center of a via hole; and FIG. 3B shows a sectional view of the transmission line, taken along the plane y-z passing through the center of a via hole. The parts shown in FIGS. 3A and 3B, which are equivalent to or the same as those shown in FIGS. 2A and 2B, are given the same reference numerals, and explanations thereof are omitted.

In the transmission line 25 shown in FIGS. 3A and 3B, a dielectric substrate 21 is formed by stacking dielectric layers 21d and 21e in that order between the dielectric layers 21a and 21b. The line electrode 22a is formed between the dielectric layers 21a and 21d, and the line electrode 22b is between the dielectric layers 21b and 21e. Another line electrode 22c, which is positioned between the line electrodes 22a and 22b, is disposed the dielectric layers 21d and 21e. Furthermore, the via holes 23 are connected not only to the line electrodes 22a and 22b, but also to the line electrode 22c.

In this arrangement, since the transmission line 25 has the three line electrodes in which signals of the same phase flow, the current concentration at the side edges of the line electrodes 22a, 22b, and 22c is further alleviated, so that losses in the transmission line can be much smaller.

As shown in FIGS. 3A and 3B, the number of line electrodes should not be limited to only two, and the transmission line may be formed by stacking three or more line electrodes to obtain the same operational advantages. Even in this case, formation can be easily conducted by using the multi-layer stacking process.

In each embodiment shown in FIG. 1, and FIGS. 3A and 3B, although the transmission line operates as a strip line having a triplate structure, for example, the dielectric layer 21a and the first ground electrode 24a may be eliminated to form a structure in which the transmission line operates as a micro-strip line, resulting in the same operational advantages.

Additionally, in the embodiment shown in FIG. 1, and FIGS. 3A and 3B, although the first ground electrodes 24a and 24b are formed on the upper and lower surfaces of the dielectric substrate 21, other structures are possible. For example, it is possible to use a structure in which another dielectric layer is disposed on the first ground electrode 24a and beneath the first ground electrode 24b. That is, a structure in which the transmission lines 20 and 25 including the first ground electrodes 24a and 24b are embedded in the dielectric substrate formed of a plurality of the dielectric layers may be used to achieve the same advantages.

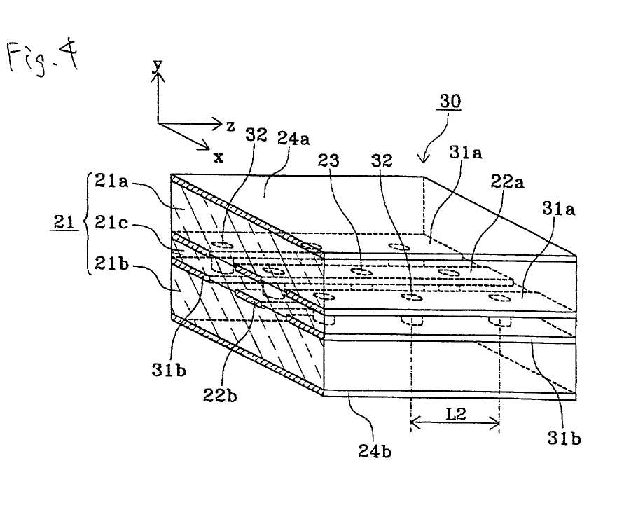

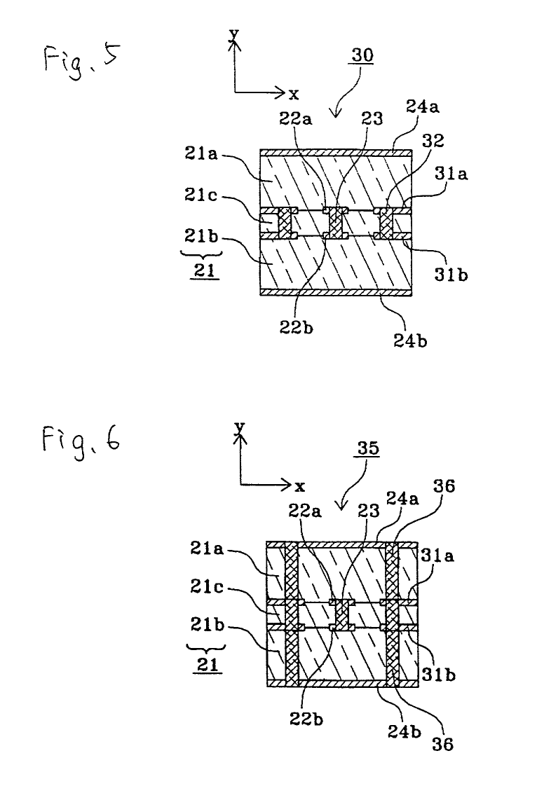

FIG. 4 shows a partial perspective view of another embodiment of the transmission line according to the present invention. FIG. 5 shows a sectional view of the transmission line 30 shown in FIG. 4, in which the sectional view is taken along the plane x-y passing through the center of a via hole. The parts shown in both FIGS. 4 and 5, which are equivalent to or the same as those shown in FIG. 1, and FIGS. 2A and 2B, are given the same reference numerals, and explanations thereof are omitted.

In the transmission line 30 shown in FIGS. 4 and 5, a second ground electrode 31a is formed in the vicinity of the edges of both sides of the line electrode 22a, on the same surface where the line electrode 22a is formed, that is, between the dielectric layers 21a and 21c. Additionally, another second ground electrode 31b is formed in the vicinity of the edges of both sides of the line electrode 22b, on the same surface where the line electrode 22b is formed, that is, between the dielectric layers 21b and 21c. The second ground electrodes 31a and 31b are connected by a via hole 32 at every predetermined distance L2 in the longitudinal direction of the line electrodes 22a and 22b at positions close to the line electrodes 22a and 22b. In this case, the distance L2 between the via holes 32 is, as in the case of the distance L between the via holes 23, set to be ¼ or less of the wavelength of signals of the highest frequency used in the transmission line 30.

In the transmission line 30 having such a structure, the line electrodes 22a and 22b serve as coplanar lines, in which the second ground electrodes 31a and 31b are used as ground electrodes. Even in this case, as in the cases of the above-described embodiments, signals of the same phase flow in the line electrodes 22a and 22b. As a result, the current concentration at the edges of the line electrodes 22a and 22b can be alleviated, and losses in the transmission line can thereby be reduced.

The transmission line 30 shown in FIGS. 4 and 5 has two line electrodes. However, the number of line electrodes should not be limited to only two, as is similar with the case of the transmission line 25 shown in FIG. 3; three or more line electrodes may be stacked to form a transmission line in order to obtain the same advantages. Even in this case, the formation of the transmission line can be easily achieved by using the multi-layer stacking process.

Furthermore, although the transmission line 30 shown in FIGS. 4 and 5 has the first ground electrodes 24a and 24b, these first ground electrodes can be eliminated to form a coplanar line structure overall to obtain similar advantages.

Furthermore, in this transmission line 30, the second ground electrodes 31a and 31b are connected by the through hole 32. However, connection structure is not limited to connection by the through holes, it is also possible to use an arrangement in which the second ground electrodes 31a and 31b are mutually connected on the end face of the dielectric substrate 21 as long as the electrodes serve as ground electrodes having equal potential with each other in a high frequency range which the transmission line is used.

Additionally, in the transmission line 30 shown in FIGS. 4 and 5, the second ground electrodes 31a and 31b are disposed on both sides of the line electrodes 22a and 22b. However, the same advantages can be obtained by disposing them on only one side of the respective line electrodes 22a and 22b.

FIG. 6 shows a sectional view of another embodiment of the transmission line according to the present invention, in which the sectional view is taken along the plane x-y passing through the center of a via hole. The parts shown in FIG. 6, which are equivalent to or the same as those shown in FIG. 5, are given the same reference numerals, and explanations thereof are omitted.

In a transmission line 35 shown in FIG. 6, the first ground electrodes 24a and 24b and the second ground electrodes 31a and 31b are mutually connected by a via hole 36 at every predetermined distance in the longitudinal direction of the line electrodes 22a and 22b at positions close to the line electrodes 22a and 22b.

In this arrangement, it can be considered that the transmission line 35 not only serves as a strip line or a coplanar line, but also substantially serves as a coaxial line having a central conductor including the line electrodes 22a and 22b, and the via hole 23, and an outer conductor including the first ground electrodes 24a and 24b, the second ground electrodes 31a and 31b, and the via hole 32. In this case, not only can the current concentration at the edges of the line electrodes 22a and 22b be alleviated, but also leakage of the electromagnetic field generated from the signals propagating through the line electrodes 22a and 22b can be reduced, so that losses in the transmission line can be further reduced.

Although the transmission line 35 shown in FIG. 6 has two line electrodes, the number of line electrodes should not be limited to only two. As in the case of the transmission line 25 shown in FIGS. 3A and 3B, a structure in which three or more line electrodes are stacked to form the transmission line can be applied to obtain the same advantages. Even in this case, formation of the transmission line can be easily conducted by using the multi-layer stacking process.

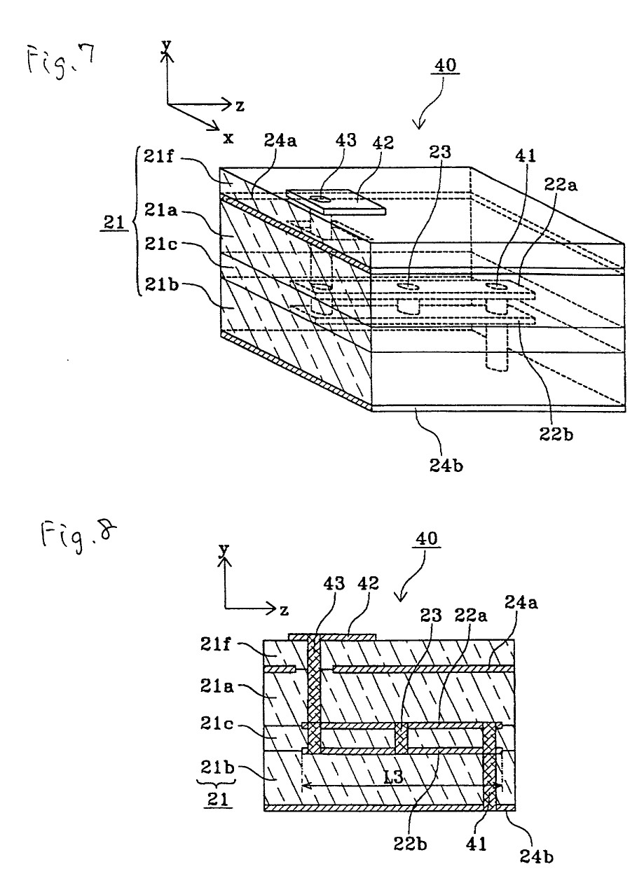

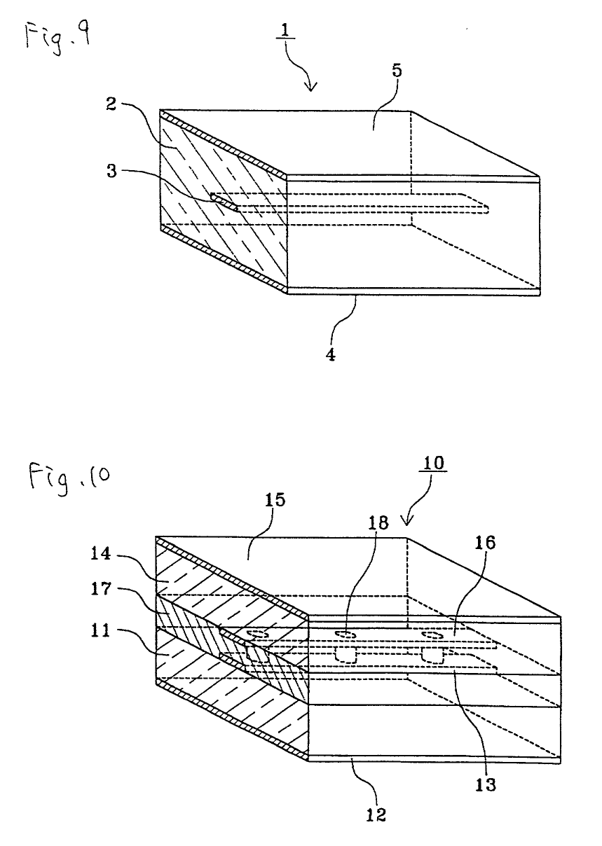

FIG. 7 shows a partial perspective view of an embodiment of a transmission line resonator according to the present invention. Furthermore, FIG. 8 shows a sectional view of the transmission line resonator 40 shown in FIG. 7, in which the sectional view is taken along the plane y-z passing through the center of a via hole. The parts shown in FIGS. 7 and 8, which are equivalent to or the same as those shown in FIG. 1, and FIGS. 2A and 2B, are given the same reference numerals, and explanations thereof are omitted.

In FIGS. 7 and 8, the transmission line resonator 40 is formed by cutting the line electrodes 22a and 22b of the transmission line 20 to a predetermined length L3, and an end of the resonator is connected to the first ground electrode 24b by a via hole 41. In this case, the length L3 is set to be ¼ of the wavelength of signals of the frequency used. As a result, the transmission line resonator 40 operates as a ¼ wavelength resonator in which one end of the resonator is grounded and the other end is open. Additionally, in the dielectric substrate 21, a dielectric layer 21f is stacked on the first ground electrode 24a, an electrode 42 is formed on the dielectric layer 21f, in which the electrode 42 is connected to the other end of the line electrodes 22a and 22b formed into the length L3 through a via hole 43 so as to be used as the input/output ends of the transmission line resonator 40.

The transmission line resonator 40 having such a structure can be a resonator having high Q, since losses in the transmission line are small. In addition, the transmission line resonator 40 can be easily obtained by using a multi-layer stacking process.

FIG. 7 shows a ¼ wavelength resonator obtained by grounding one end of the transmission line 20, which is cut to a desired length. However, another structure, for example, a structure in which both ends of the transmission line 20 are open to form a ½ wavelength resonator, may be used.

Although the transmission line resonator shown in FIG. 7 is formed by using the transmission line 20 shown in FIG. 1, it can also be formed by using the transmission line respectively shown in FIGS. 3A and 3B, 4, and 6.

The transmission of the present invention includes a plurality of strip line electrodes and a plurality of dielectric layers, in which the respective strip line electrodes are mutually stacked via the dielectric layers, and are mutually connected by via holes disposed at distances of ¼ or less of the wavelength of signals of the highest frequency used in the longitudinal direction of the line electrode. With this arrangement, current concentration at the edges of the line electrodes can be reduced, and losses in the transmission line can thereby be reduced. Moreover, since formation of the parts can be conducted by the same process, production efficiency can be enhanced and cost reduction can be achieved.

The transmission line of the present invention is allowed to operate as a strip line or a micro-strip line with smaller losses by disposing first ground electrodes separated by the dielectric layers with respect to the line electrodes in a direction in which the line electrodes are stacked.

Furthermore, on the same plane where the line electrodes are disposed, second ground electrodes are disposed respectively at positions close to the edges of the line electrode. At positions close to the line electrodes, the respective second ground electrodes are mutually connected by via holes disposed at predetermined distances in the longitudinal direction of the line electrodes, so that the transmission line is allowed to serve as a coplanar line with reduced losses.

Furthermore, at positions close to the line electrodes, the first ground electrodes and the second ground electrodes are mutually connected by via holes disposed at predetermined distances in the longitudinal direction of the line electrodes, leakage of the electromagnetic field generated from the signals flowing through the line electrodes can be small. Thus, losses in the transmission line can be further reduced.

Additionally, in the transmission line resonator in accordance with the present invention, the resonator can have a higher Q by using the above-described transmission line of a limited length.

What is claimed is:

1. A transmission line comprising:
a plurality of strip line electrodes; and
a plurality of dielectric layers;
wherein the strip line electrodes are mutually stacked via the dielectric layers and are mutually connected through via holes disposed at predetermined distances in the longitudinal direction of the strip line electrodes.

2. A transmission line according to claim 1, wherein first ground electrodes are disposed separated by the dielectric layers with respect to the strip line electrodes, in a direction in which the strip line electrodes are stacked.

3. A transmission line according to claim 2, wherein second ground electrodes are disposed at positions in the vicinity of edges of the strip line electrodes, on the same plane as the strip line electrodes are disposed.

4. A transmission line according to claim 3, wherein the second ground electrodes are mutually connected through the via holes disposed at predetermined distances in the longitudinal direction of the strip line electrodes, at positions close to the strip line electrodes.

5. A transmission line according to claim 4, wherein the first ground electrodes and the second ground electrodes are mutually connected by the via holes disposed at predetermined distances in the longitudinal direction of the line electrodes, at positions close to the line electrodes.

6. A transmission line according to claim 1, wherein the respective second ground electrodes are disposed at positions close to the edges of the strip line electrodes, on the same plane as the strip line electrodes are disposed.

7. A transmission line according to claim 6, wherein the second ground electrodes are mutually connected through the via holes disposed at predetermined distances in the longitudinal direction of the strip line electrodes, at positions close to the strip line electrodes.

8. A transmission line according to one of claims 1 through 7, wherein the distance between the via holes is set at ¼ or less of the wavelength of signals of the highest frequency used.

9. A transmission line resonator comprising one of the transmission lines according to claims 1 through 8, in which the length of the transmission line has a predetermined length.
